(19) United States
(12) Patent Application Publication
(10) Pub. No.: US 2014/0163457 A1
(43) Pub. Date: Jun. 12, 2014

(54) GASTRIC TUBE REGULATION SYSTEM

(71) Applicant: Daniel M. Kelly, St. Paul, MN (US)

(72) Inventor: Daniel M. Kelly, St. Paul, MN (US)

(21) Appl. No.: 13/708,030

(22) Filed: Dec. 7, 2012

(51) Int. Cl. A61J 15/00; F16K 24/00

(52) U.S. Cl. CPC A61J 15/0096; A61J 15/0015; F16K 24/00
USPC 604/28; 604/45; 137/583

(57) ABSTRACT

A regulator system for handling the flow of gases and fluids between a nutrient and medication supply system and an implanted g-tube using an intermediate chamber to cause phase separation of any gases entrained within the supply stream or backflow from the g-tube. The chamber is vented to allow escape of the separated gases while acting as a temporary reservoir retaining any solids or liquids for feeding into or return to the stomach through the g-tube.

### FIELD OF THE INVENTION

The present invention is generally directed to a regulator system for a gastric tube (“g-tube”) medication or nutrient delivery system. Specifically, the present invention is directed to an inline regulator system that controls gas and fluid flow through the g-tube delivery system in either direction.

### BACKGROUND OF THE INVENTION

G-tube nutrient or medication delivery systems are systems in which a g-tube is inserted through the abdomen wall and into the stomach for delivery of nutrient or medication solutions directly into the patient's stomach. G-tubes are ordinarily no more than sterilized plastic tubing with fixation devices that prevent the tubing from being inadvertently removed. The simplicity of the g-tubes necessarily simplifies the installation of the g-tube as g-tubes are frequently inserted and maintained by individuals without medical training, such as family caretakers or the patient themselves. However, the simplicity of g-tube feeding systems also presents a number of inherent challenges that can present significant challenges for caregivers as well as significant health risks for patients.

Unlike natural stomach openings that are opened or closed by the stomach muscles surrounding the opening, the g-tube opening is surgically formed and as such has no surrounding muscles to selectively open or close the mouth of the g-tube opening. Instead, the g-tube is often designed to specifically prevent the mouth of the g-tube opening from healing closed to avoid uncontrolled closure of the g-tube opening. The inability to selectively open or close the mouth of the g-tube opening prevents the stomach from naturally controlling the flow of fluids and gases through the g-tube. As a result, stomach contents frequently enter the g-tube and clog the g-tube. Despite the risk of clogging the g-tube, flow through the g-tube in either direction is often unrestricted as the g-tube can serve as a vent through which gases generated during digestion can be vented. Accordingly, patients or caregivers are often instructed to accommodate the venting process by frequently flush the g-tube prior to each feeding or medicating rather than attempt to prevent the stomach contents from entering the g-tube. Even with frequent cleaning, g-tubes often become unusable after a short period of time and must be regularly replaced. The frequent cleaning and replacement of the g-tube can be expensive and often taxing for patients and care givers, who often only have very basic training in the use and replacement of the g-tube. The lack of medical training can also create significant risk of infection or complication for the patient or caregiver if the g-tube is not properly handled or positioned.

Moreover, when a nutrient or medication supply system is not connected to the g-tube, the digestion gases created within the stomach can push the stomach contents out of the stomach during venting and expel the contents from the g-tube. Accordingly, patients must often take special precautions to avoid spilling the stomach contents when sleeping or when the g-tube is not carefully monitored. In addition to creating a biologically hazardous situation, the patient loses valuable nutrients and medications contained within the stomach contents that are often particularly necessary for a recovering patient. Similarly, when the supply system is connected, the gases can push the stomach contents through the g-tube and clog or contaminate the supply system.

Although g-tubes significantly simplify the feeding and medicating process, the inherent challenges of maintaining g-tubes in proper working order can create substantial challenges for patients and caretakers. Accordingly, there is need for efficiently controlling the flow of gases and solids through the nutrient and medication system in either direction.

### SUMMARY OF THE INVENTION

A regulator system for handling the flow of gases and fluids between a nutrient and medication supply system and an implanted g-tube, according to an embodiment of the present invention, can comprise a container assembly defining a generally vertical chamber positioned between an inlet assembly at the top of the container and an outlet assembly at the bottom of the chamber. A supply system can be linked to the inlet assembly for providing a nutrient or medication solution into the container. A g-tube implanted into the stomach can be linked to the outlet of the container for receiving the nutrient or medication solution from the supply system. The chamber acts a gravimetric separator for separating gases and fluids that are received within the chamber from either the nutrient or medication supply solution or the backflow from the stomach through the g-tube. The container further comprises at least one vent hole at the top of the container for venting gases separated from the supply solution or the stomach backflow. The chamber generally operates as a temporary reservoir for capturing and retaining the desired fluids as the gases are separated from the fluids for venting. The chamber retains the desired fluids before the fluids are drained through the outlet assembly and into the patient through the g-tube.

The outlet assembly can further comprise a valve operable to restrict or permit the flow of supply solution or back flow between the g-tube and the chamber. When administering a supply solution, the valve is opened to allow the supply solution to enter the g-tube and on to the patient. In one aspect, bottom of the container can be shaped to funnel any fluid within the container into the outlet assembly and the valve. As the supply solution enters the container any air bubbles within the supply solution separate from the solution and collect within the container until vented through the vent hole. Similarly, between feeding the valve can remain open to allow backflow from the stomach to travel through the g-tube and into the chamber. In one aspect, the valve can be closed to capture and retain a portion of the stomach contents or supply solution within the reservoir. In one aspect, the outlet valve can comprise a secondary inlet for administering a cleaning solution directly into the g-tube for flushing the g-tube while retaining the desired fluids within the chamber until the g-tube is flushed.

Similarly, the clamp can also isolate the g-tube for separation of the feeding system or cleaning of the chamber to prevent uncontrolled backflow of fluids out of the g-tube such as when the container is disconnected from the g-tube. In one aspect, the secondary inlet can be used to add a medication to a feed solution being administered to the patient as the feed solution passes through the dissipation chamber. In one embodiment of the present invention, the container can comprise an upper portion comprising the inlet valve and a separable lower portion comprising the outlet assembly. The lower portion can be interchanged with different size lower portions. The different lower portions can be interchanged to change the relative size of the chamber and correspondingly the amount of fluid that can be retained within the chamber.

The chamber can also contain the pressurized backflow and separate the stomach gases from the liquid and solid contents of the backflow. The gases can be vented from the chamber through the vent to vent the digestion gases generated within the patient's stomach. In this configuration, the regulator system can operated passively to contain any backflow within the container, depressurize backflow by separating out the gases, vent the gases and allow the depressurized backflow to drain back through the outlet assembly to the patient.

In one aspect, the vents in the chamber are shielded to prevent the solid and liquid components of the pressurized stomach contents from exploding through the vents as the pressurized backflow enters the chamber through the outlet assembly while still venting the gases to reduce the pressure of the backflow. In this configuration, the positioning of the inlet assembly at the top of the container reduces the amount of backflow that reaches the inlet assembly and gravimetrically limits the amount of backflow that can enter the inlet assembly. In another aspect, the vents are closable to prevent passage of any gases out of the chamber. In this configuration, the nutrient and medication solution from the supply system can be pressurized to pump the solution into the patient through the g-tube.

In one aspect, the regulator system could comprise at least one strap for suspending the container from a patient's body. In this configuration, the patient can wear the container while linked to the g-tube to provide the venting advantages of the container without requiring the patient to be in a static position. In one aspect, the container could be linked to a supply container containing a medication and/or nutrient solution for supplying a medication/nutrient stream to the container while the patient is mobile.

A regulator system, according to an embodiment of the present invention, comprises a container having an inlet assembly, an outlet assembly and at least one vent. The container defines a chamber for collecting fluids that enter the chamber and gravimetrically separating the fluids from any gases contained within the fluids. In one aspect, the vent is positioned to vent the gases separated from fluids entering the container. The inlet assembly is positioned at the top of the chamber and can be linked to a supply line for a nutrient and/or medication feed system. The outlet assembly is positioned at the bottom of the chamber and linked to a g-tube implanted into a patient's stomach. In one aspect, the outlet assembly can further comprise a closable valve and a secondary inlet.

A regulator system, according to an embodiment of the present invention, comprises a container having a top portion and a plurality of interchangeable bottom portions. The top portion can further comprise an inlet assembly and at least one vent. Each bottom portion can further comprise an outlet assembly and is attachable to the top portion to define a chamber within the container. In one aspect, each bottom portion can comprise a different size such that the volume of the defined chamber can be varied by changing the bottom portion. In this configuration, a larger bottom portion can be attached to the top portion when the container is operating purely to contain backflow from the stomach versus a smaller bottom portion used for feeding. The inlet assembly is positioned at the top of the chamber and can be linked to a supply line for a nutrient and/or medication feed system. The outlet assembly is positioned at the bottom of the chamber and linked to a g-tube implanted into a patient's stomach.

A method of administering a nutrient or medication solution from a supply system through an implanted g-tube, according to an embodiment of the present invention, comprises providing a container having a vent, an inlet assembly linked to the supply system and an outlet assembly linked to the g-tube, wherein the container defines a chamber between the inlet and outlet assemblies. The method further comprises orienting the container such that the inlet assembly is at the top of the container and the outlet assembly is at the bottom of the container. The method also comprises pumping the solution into the container through the inlet assembly, wherein the vertical orientation and greater radial diameter of the container causes any gases within the solution to gravimetrically separate from the solution. The method further comprises venting the separated gases through the vent. The method also comprises funneling the degassed solution into the outlet assembly and into the g-tube.

A method of controlling backflow from a patient's stomach through a g-tube, according to an embodiment of the present invention, comprises providing a container having a vent, an inlet assembly linked to the supply system and an outlet assembly linked to the g-tube, wherein the container defines a chamber between the inlet and outlet assemblies. The method further comprises orienting the container such that the inlet assembly is at the top of the container and the outlet assembly is at the bottom of the container. The method also comprises containing any pressurized backflow that enters the container through the outlet assembly. The method further comprises gravimetrically separating the stomach gases from the liquid portions of the stomach contents. The method further comprises closing the outlet assembly to retain the backflow within the chamber and venting the separated gases through the vent. The method also comprises funneling the degassed backflow into the outlet assembly and into the g-tube.

A method of controlled venting of a patient's stomach through a g-tube, according to an embodiment of the present invention, comprises providing a container having a vent, an inlet assembly linked to the supply system and an outlet assembly linked to the g-tube, wherein the container defines a chamber between the inlet and outlet assemblies. The method further comprises orienting the container such that the inlet assembly is at the top of the container and the outlet assembly is at the bottom of the container. The method also comprises positioning the container below the patient's body such that any gases, fluids, or solids released from the patient's stomach enter the container through the outlet assembly. The method further comprises closing a valve within the outlet assembly to retain the expelled backflow from the stomach and gravimetrically separating any gases from the fluids and solids. The method also comprises venting the separated gases from the chamber. Finally, the method further comprises elevating the chamber and opening the valve to gravimetrically drain the retained backflow back into the patient's stomach through the g-tube.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a schematic diagram of a g-tube medication or nutrient delivery system with a regulator system according to an embodiment of the present invention.

FIG. 2 is a side view of a regulator system according to an embodiment of the present invention.

FIG. 3 is a partial cross-sectional side view of a regulator system illustrating a nutrient or medication solution entering a chamber of a regulator system with an open valve according to an embodiment of the present invention.

FIG. 4 is a partial cross-sectional side view of a regulator system illustrating a nutrient or medication solution entering a chamber of a regulator system with an open valve according to an embodiment of the present invention.

FIG. 5 is a partial cross-sectional side view of a regulator system illustrating backflow from a patient's stomach entering a chamber of a regulator system through a g-tube according to an embodiment of the present invention.

FIG. 6 is a partial cross-sectional side view of a regulator system illustrating a nutrient or medication solution or backflow leaving a chamber of a regulator system with an open valve according to an embodiment of the present invention.

FIG. 7 is a side view of a bottom portion of a container of a regulator system according to an embodiment of the present invention.

FIG. 8 is a side view of a container of a regulator system according to an embodiment of the present invention.

FIG. 9 is a top view of a suspension system of a regulator system according to an embodiment of the present invention.

FIG. 10 is a partial side view of a regulator system suspended with a suspension system according to an embodiment of the present invention.

While the invention is amenable to various modifications and alternative forms, specifics thereof have been depicted by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

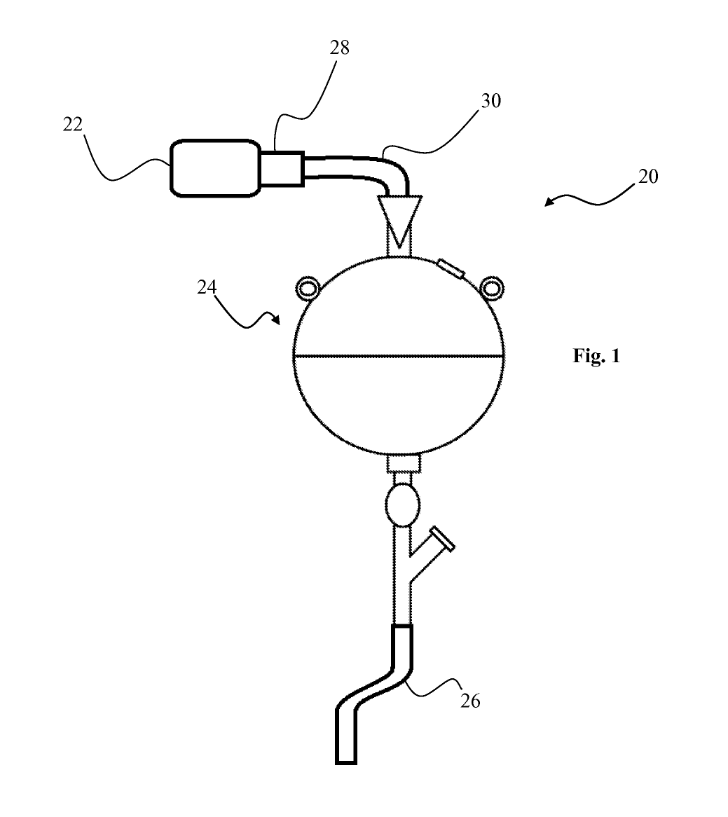

As depicted in FIG. 1, a g-tube nutrient and medication delivery system 20, according to an embodiment of the present invention, comprises a nutrient and medication supply system 22, a regulator system 24 and a g-tube 26. The supply system 22 can comprise a pump 28 for administering a medication or nutrient solution through a supply line 30 connected to the regulator system 24. The g-tube 26 is implanted through the patient's stomach and connected to the regulator system 24 such that the regulator system 24 is positioned between the supply system 22 and the g-tube 26.

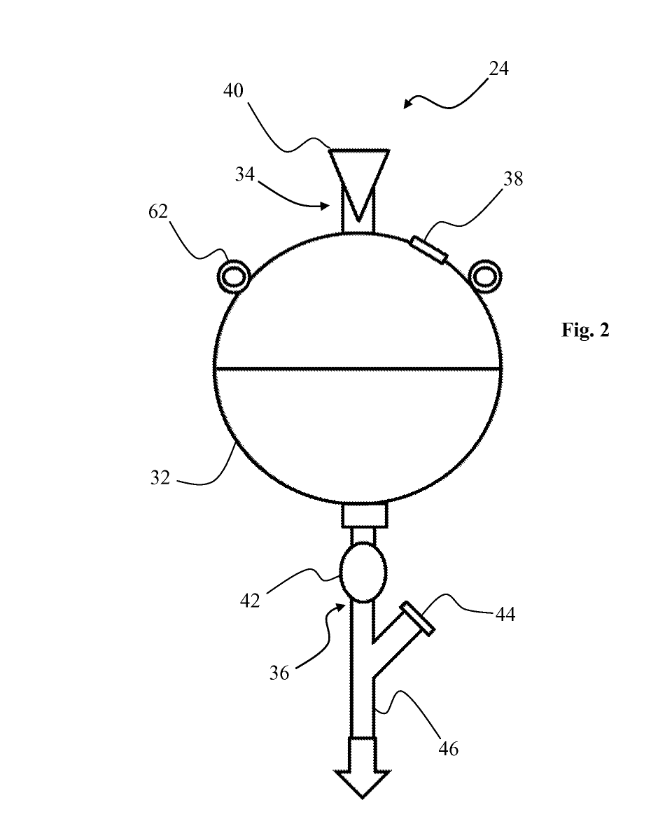

As depicted in FIG. 2, a regulator system 24, according to an embodiment of the present invention, comprises a container 32 having an inlet assembly 34, an outlet assembly 36 and at least one vent 38. The container 32 defines a chamber for receiving a nutrient or medication solution from the supply system 22 or backflow from the stomach. In one aspect, the chamber comprises a greater radial diameter than the supply line 30 and the g-tube 26 to provide sufficient volume to facilitate gravitational separation of the gas and liquid/solid phases of the supply solution or backflow. The inlet assembly 34 is positioned at the top of the container 32 further comprises a connector 40 for linking the inlet assembly 34 to the supply line 30. The outlet assembly 36 is positioned at the bottom of the container 32 and further comprises a valve 42, a secondary inlet 44 and a connector 46 engageable to the g-tube 26.

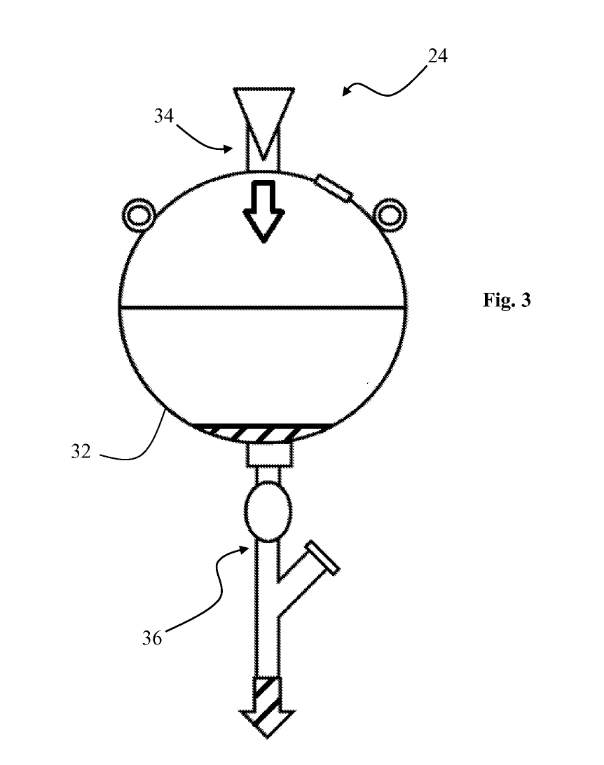

As depicted in FIGS. 3-4 and 6, during feeding or medicating, a supply solution is pumped by the pump 28 through the inlet assembly 34 and into the chamber of the container 32. In one aspect, the valve 42 can be initially closed such that a quantity of the supply solution is retained within the container. The retained supply solution volumetrically separates such that any air bubbles contained within the supply solution or introduced by the pump 28 or supply line 30 are separated from the liquid portion of the supply solution and vented through the vent 38. The valve 42 can then be opened to permit the retained supply solution to drain through the outlet assembly 36 into the g-tube 26 and onto the patient. In another aspect, the valve 42 can remain during feeding, wherein the greater radial diameter of the chamber facilitates the separation of the air bubbles from the supply solution. In one aspect, a secondary supply solution can be administered directly into the g-tube 26 via the secondary inlet 44 alone or mixed with the supply solution from the container 32 as the supply solution passes through the outlet assembly 36.

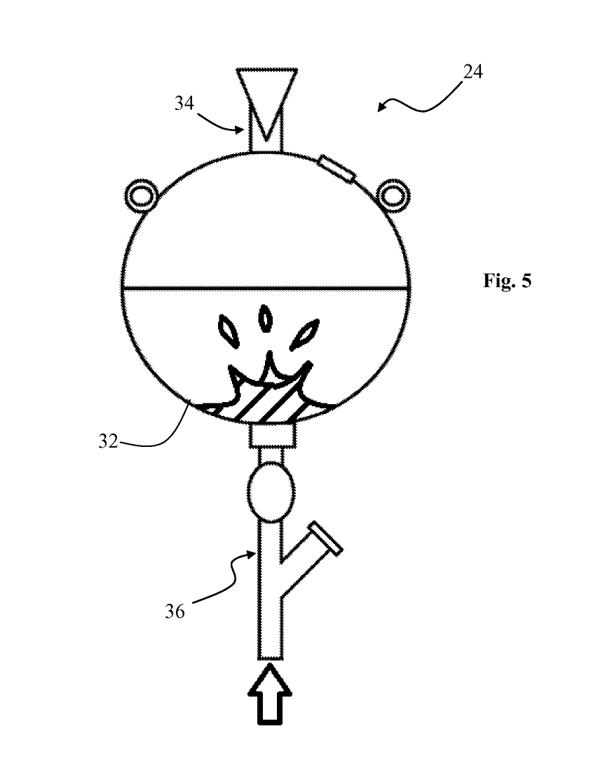

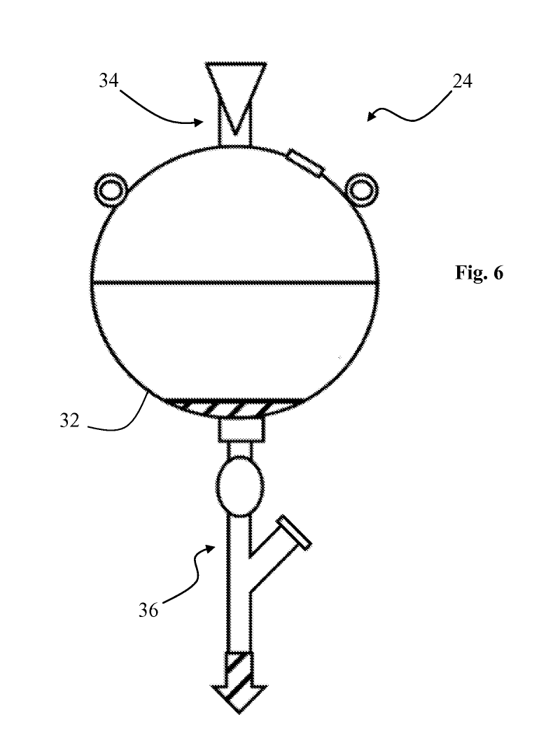

As depicted in FIGS. 5-6, between feeding or during venting, backflow from the stomach can enter the g-tube 26 and pass through the inlet assembly 34 to enter the chamber. The container 32 contains the pressurized backflow within the chamber as the backflow enters the chamber. In one aspect, the chamber can be sized to retain an ordinary quantity of backflow while retaining a headspace above the backflow within the chamber. The expanded radius of the chamber depressurizes the backflow and vents the stomach gas through the vent 38. Once the backflow and the stomach is sufficiently depressurized, any backflow contained within the container 32 is funneled back into the outlet assembly 36 and returned to the stomach via the supply line 30 preventing loss of any nutrients or medications contained within the backflow.

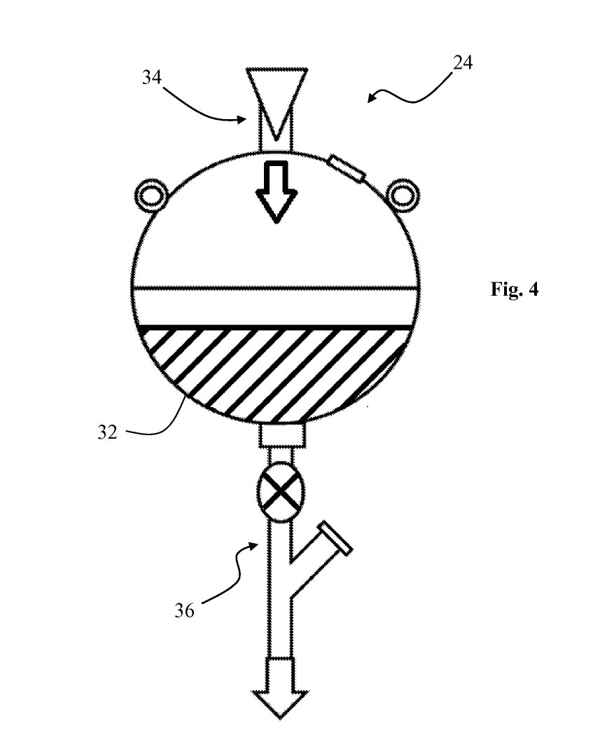

As depicted in FIG. 4, the valve 42 can be closed to retain any supply solution or backflow within the container 32 at the time. A cleaning solution can then be administered via the secondary inlet 44 to flush any clogs or backflow within the g-tube 26 out of the g-tube 26 and into stomach. In one aspect, the valve 42 can be closed to separate any fluids or solids retained within the container 32 from the cleaning solution used to flush the g-tube 26. The valve 42 can then be opened to permit any of the retained fluids to enter the g-tube 26 and onto the stomach.

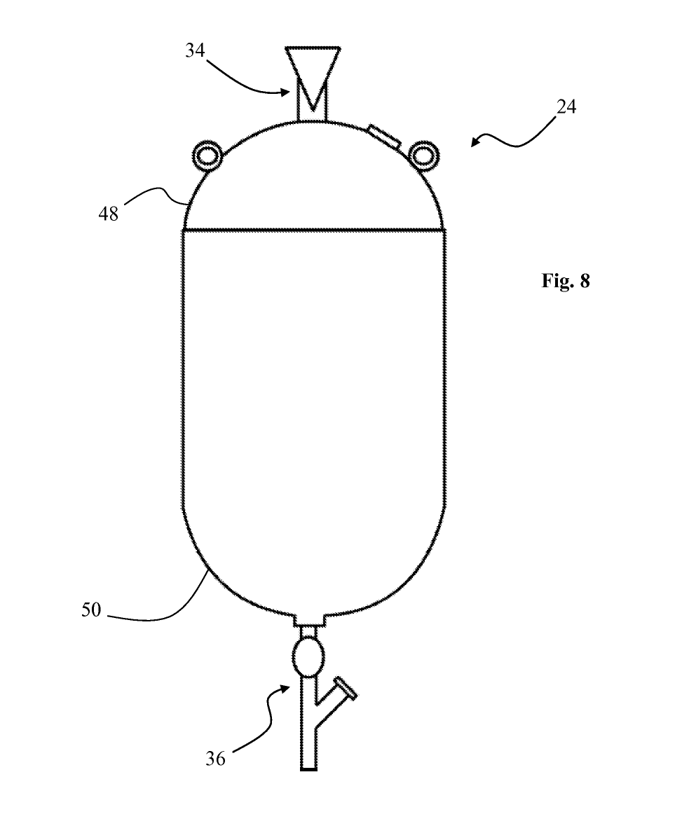

As depicted in FIG. 2, in one aspect, the chamber defined by the container 32 can comprise a spherical shape. In another aspect depicted in FIG. 8, the chamber can define a cylindrical shape with a rounded portion at the top of the container 32 proximate to the inlet assembly 34 and at the bottom of the container 32 proximate to the outlet assembly 36. In yet another aspect, the chamber can further comprise conical shaped end portions at the top of the container 32 proximate to the inlet assembly 34 and at the bottom of the container 32 proximate to the outlet assembly 36. The rounded or conical shape of the chamber contains supply solution or backflow entering the container 32 and directs the fluids into the outlet assembly 36 for funneling into the g-tube 26.

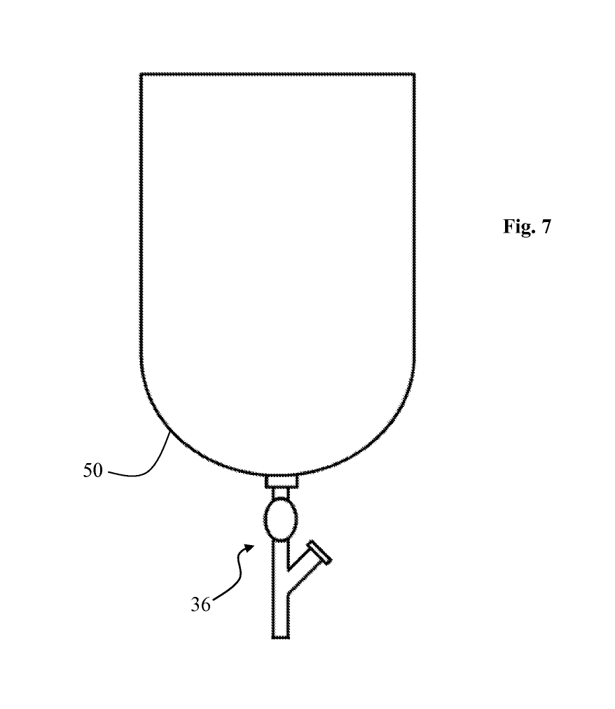

As depicted in FIGS. 7-8, in an embodiment of the present invention, the container 32 can further comprise a top portion 48 and a separable bottom portion 50 that can be combined to define the chamber. In this configuration, the top portion 48 defines a top well cavity 52 and comprises the inlet assembly 34. Similarly, the bottom portion 50 defines a bottom well cavity 54 and comprises the outlet assembly 36. In one aspect, the regulator system 24 can comprise a plurality of interchangeable bottom portions 50 each having a different sized bottom well cavity 54. The interchangeable bottom portions 50 can be interchangeably linked to the top portion 48 to change the overall volume of the chamber.

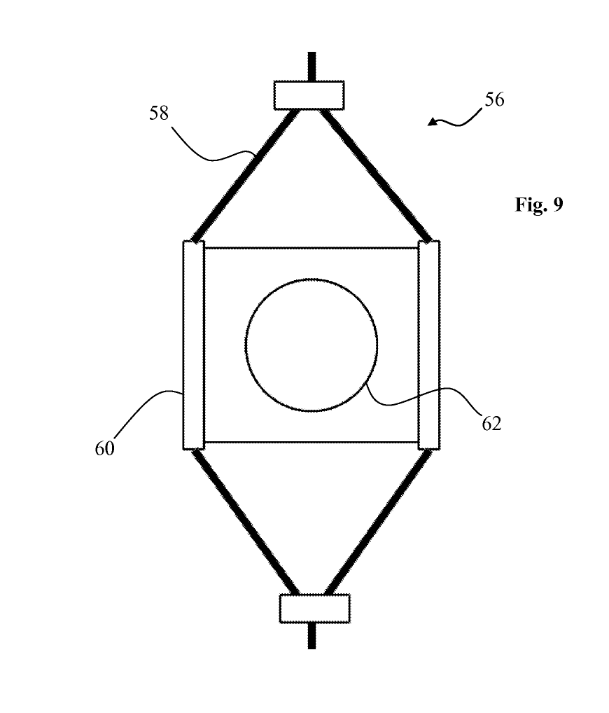

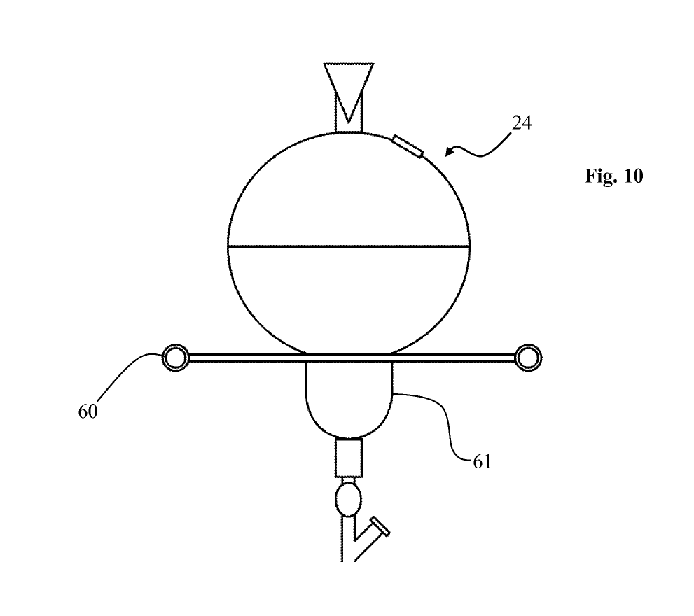

As depicted in FIGS. 9-10, in an embodiment of the present invention, the regulator system 24 can further comprise a suspension system 56 for elevating the container 32 above the patient. The suspension system 56 can further comprise at least one strap 58 and a cradle 60 defining at least one opening 62 for receiving a portion of the container 32. In one aspect, the container 32 can comprise a reduced diameter portion 61 insertable into the opening 62 for maintaining the container 32 within the suspension system 56. The strap 58 can be secured to various objects for positioning the cradle 60 generally above the patient. The cradle 60 suspends the container 32 in a general vertical orientation with the inlet assembly 34 generally positioned above the outlet assembly 36. The cradle 60 is suspended a predetermined distance above the patient corresponding to the length of the g-tube 26. In one aspect, the predetermined distance is sized such that more of the g-tube 26 is generally vertical than generally horizontal. In another aspect, the cradle 60 is suspended at least 12 to 24 inches above the patient.

As depicted in FIG. 1, in an embodiment of the present invention, the container 32 can further comprise at least one strap loop 62 engageable by strap 64. The strap loop 62 can be used individually to suspend the container 32 or used in conjunction with the cradle 60 to suspend the container 32 and maintain the container 32 in a generally vertical orientation.

A method of administering a nutrient or medication solution from the supply system 22 through the g-tube 26, according to an embodiment of the present invention, comprises positioning a container 32 having a vent 38, an inlet assembly 34 linked to the supply system 22 and an outlet assembly 36 linked to the g-tube 26, wherein the container 32 defines a chamber between the inlet and outlet assemblies 34, 36. The method further comprises orienting the container 32 such that the inlet assembly 34 is at the top of the container and the outlet assembly 36 is at the bottom of the container 32. The method also comprises pumping the solution into the container 32 through the inlet assembly 45, wherein the vertical orientation and the greater radial diameter of the container 32 causes any gases within the solution to gravimetrically separate from the solution. The method further comprises venting the separated gases through the vent 38. The method also comprises funneling the degassed solution into the outlet assembly 36 and into the g-tube 26.

A method of controlling backflow from a patient's stomach through the g-tube 26, according to an embodiment of the present invention, comprises providing a container 32 having a vent 38, an inlet assembly 34 linked to the supply system 22 and an outlet assembly 36 linked to the g-tube 26, wherein the container defines a chamber between the inlet and outlet assemblies 34, 36. The method further comprises orienting the container 32 such that the inlet assembly 34 is at the top of the container 32 and the outlet assembly 36 is at the bottom of the container 32. The method also comprises containing any pressurized backflow that enters the container 32 through the outlet assembly 36. The method further comprises gravimetrically separating the stomach gases from the liquid portions of the stomach contents. The method further comprises closing the outlet assembly 36 to retain the backflow within the chamber and venting the separated gases through the vent 38. The method also comprises funneling the degassed backflow into the outlet assembly 36 and into the g-tube 36.

While the invention is amenable to various modifications and alternative forms, specifics thereof have been depicted by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A regulator system for controlling flow of fluids and solids through a g-tube feeding system, comprising:
an inlet assembly positioned at the top of the container and defining an inlet opening for receiving fluids and solids into the chamber;
an outlet assembly positioned at the bottom of the container and defining an outlet opening for receiving fluids and solids into the chamber and draining fluids and solids gravimetrically from the chamber, wherein the outlet assembly further comprises a valve for selectively closing the outlet opening to retain a quantity of fluids and solids within the chamber for gravimetrically separating any gases entrained within the retained quantity of fluids and solids; and
at least one vent positioned proximate to the inlet assembly at the top of the container for venting the gravimetrically separated gases.

2. The regulator system of claim 1, wherein the inlet opening comprises a diameter less than a cross-sectional diameter of the chamber such that fluids and solids entering the chamber through the inlet assembly enter a volumetrically expanded area separating gases from liquids and solids.

3. The regulator system of claim 1, wherein the outlet opening comprises a diameter less than a cross-sectional diameter of the chamber such that fluids and solids entering the chamber through the outlet assembly enter a volumetrically expanded area separating gases from liquids and solids.

4. The regulator system of claim 1, wherein the container comprises a funnel shape at the bottom to direct solids and fluids within the chamber through the outlet opening.

5. The regulator system of claim 1, wherein the vent is shielded to allow escape of gases separated from fluids and solids retained within the chamber while preventing escape of fluids and solids through the vent.

6. The regulator system of claim 1, wherein the container further comprises a separable top portion and bottom portion, wherein the bottom portion can be interchanged with a second bottom portion to define a second chamber having a different volume.

7. The regulator system of claim 1, wherein the outlet assembly further comprises a secondary inlet for administering a supply solution into fluids and solids exiting the chamber through the outlet assembly.

8. A g-tube feeding system, comprising:
a supply system having a supply tube for transferring a supply stream from the supply system;
a g-tube at least partially insertable into a patient's stomach;
a container having a top and bottom and defining an elongated chamber;
an inlet assembly positioned at the top of the container and defining an inlet opening for receiving fluids and solids into the chamber, wherein the supply tube is fluidly connected to the inlet opening for feeding the supply stream into the chamber;
an outlet assembly positioned at the bottom of the container and defining an outlet opening for receiving fluids and solids into the chamber and draining fluids and solids out of the chamber, wherein the g-tube is fluidly connected to the outlet opening for conveying the supply stream from the chamber into the patient's stomach and receiving backflow from the patient's stomach, wherein the outlet assembly further comprises a valve for selectively closing the outlet opening to retain solids and fluids within the chamber to gravimetrically separate any gases entrained within the solids and fluids; and
at least one vent positioned proximate to the inlet assembly at the top of the container for venting the separated gases from the chamber.

9. The regulator system of claim 8, wherein the inlet opening comprises a diameter less than a cross-sectional diameter of the chamber such that supply stream entering the chamber through the inlet assembly from the supply tube enters a volumetrically expanded area separating any gases contained within the supply stream from liquids and solids.

10. The regulator system of claim 8, wherein the outlet opening comprises a diameter less than a cross-sectional diameter of the chamber such that backflow entering the chamber through the outlet assembly from the g-tube enters a volumetrically expanded area separating any gases contained within the backflow from liquids and solids.

11. The regulator system of claim 8, wherein the container comprises a funnel shape at the bottom to direct solids and fluids contained within the chamber through the outlet opening.

12. The regulator system of claim 8, wherein the vent is shielded to allow escape of gases separated from fluids and solids retained within the chamber while preventing escape of fluids and solids through the vent.

13. The regulator system of claim 8, wherein the container further comprises a separable top portion and bottom portion, wherein the bottom portion can be interchanged with a second bottom portion to define a second chamber having a different volume.

14. The regulator system of claim 8, wherein the outlet assembly further comprises a secondary inlet for administering a supply solution into fluids and solids exiting the chamber through the outlet assembly.

15. A method of regulating flow of fluids and solids through a g-tube feeding system, comprising:
providing a container having a top defining a inlet opening and a bottom defining an outlet opening, wherein the container further comprises at least one vent proximate the inlet opening;
fluidly connecting a supply tube to the inlet opening for providing a supply stream into the chamber through the inlet opening;
fluidly connecting a g-tube extending from a patient's stomach to the outlet opening for receiving the supply stream fed into the chamber and delivering backflow from the patient's stomach into chamber;
selectively actuating a valve positioned at outlet opening to selectively open and close the valve to temporarily retain fluids and solids within the chamber to cause gravimetric phase separation of any gases entrained within the retained fluids and solids;
venting the separated gases through the vent.

17. The method of claim 15, further comprising containing any liquid or solid backflow from the patient's stomach through the g-tube within the chamber;
draining the contained liquid or solid backflow through the g-tube back to the patient's stomach; and
venting any gas backflow from the patient's stomach through the vent.

18. The method of claim 15, further comprising providing a secondary inlet between the outlet of the chamber and the g-tube for introducing a secondary stream with fluids and solids exiting the chamber.

19. The method of claim 15, wherein the method further comprises introducing a cleaning solution through the secondary inlet to flush the g-tube.

20. The method of claim 15, wherein the container further comprises a separable top portion and a bottom portion;
providing a plurality of interchangeable bottom portions each defining a different internal volume, wherein the plurality of bottom portions are affixable to the top portion to provide chambers of different volumes.
